(19) United States
(12) Patent Application Publication
(10) Pub. No.: US 2020/0281006 A1
(43) Pub. Date: Sep. 3, 2020

(54) CARRIER PREFERENCE MEASUREMENT AND INDICATION

(71) Applicant: QUALCOMM Incorporated, San Diego, CA (US)

(72) Inventors: Akash KUMAR, Hyderabad (IN); Hargovind Prasad Bansal, Hyderabad (IN)

(21) Appl. No.: 16/803,186

(22) Filed: Feb. 27, 2020

(30) Foreign Application Priority Data
Feb. 28, 2019 (IN) 201941007896

(51) Int. Cl. H04W 72/12; H04W 72/14; H04W 76/28

(52) U.S. Cl. CPC H04W 72/1231; H04W 76/28; H04W 72/14; H04W 72/1284

(57) ABSTRACT

In a carrier aggregation or EN-DC scenario, there exist multiple different conditions based on which UE would benefit from a higher or lower grant ratio on a specific carrier as opposed to other carriers. There are a number of criteria based on which UE may select a preferred carrier for uplink grant reception. Some example criteria include self-jamming conditions, thermal constraints, and inter-RAT interference. These and other criteria may form a basis for identifying preferred carriers, non-preferred carriers, or ranking carriers. Various embodiments described provide techniques for a UE to indicate preferred and non-preferred carriers to a serving base station. A serving base station, in turn, can make use of the indication to adjust the ratio at which uplink transmissions are scheduled on these carriers.

### CROSS-REFERENCE TO RELATED APPLICATION

This application claims priority to Indian Application No. 201941007896, filed on Feb. 28, 2019, entitled “CARRIER PREFERENCE MEASUREMENT AND INDICATION,” which is hereby expressly incorporated by reference herein.

### BACKGROUND

### Technical Field

The present disclosure relates generally to communication systems, and more particularly, to carrier allocation of carriers for transmissions in multi-carrier scenarios.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

Multiple access technologies have been adopted in various telecommunication standards to provide a common protocol that enables different wireless devices to communicate on a municipal, national, regional, and even global level. An example telecommunication standard is 5G New Radio (NR).

5G NR is part of a continuous mobile broadband evolution promulgated by Third Generation Partnership Project (3GPP) to meet new requirements associated with latency, reliability, security, scalability (e.g., with Internet of Things (IoT)), and other requirements. Some aspects of 5G NR may be based on the 4G Long Term Evolution (LTE) standard. There exists a need for further improvements in 5G NR technology.

These improvements may also be applicable to other multi-access technologies and the telecommunication standards that employ these technologies.

### BRIEF SUMMARY

The following presents a simplified summary of one or more aspects to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a UE. The apparatus may measure carrier quality on a plurality of carriers, identify a first carrier from the plurality of carriers. The first carrier may correspond to a first measured carrier quality. The apparatus may send an uplink transmission to a base station, the uplink transmission including a first carrier indicator corresponding to the first carrier, and receive an uplink grant from the base station based on the uplink transmission. The first measured carrier quality may be a highest measured carrier quality or lowest measured carrier quality.

In another embodiment, the apparatus may also identify a second carrier from the plurality of carriers, the second carrier may correspond to a second measured carrier quality. Additionally, the uplink transmission may include a second carrier indicator corresponding to the second carrier. The first measured carrier quality may be a highest measured carrier quality, and the second measured carrier quality may be a lowest measured carrier quality. The apparatus may also receive a downlink transmission from the base station including a DTX configuration for at least one of the first carrier and the second carrier in response to the uplink transmission.

In one embodiment, the uplink transmission may include a buffer status report (BSR). The apparatus may receive an indication from the base station of a BSR format, where the BSR format includes a first carrier indicator field and a second carrier indicator field. In another embodiment, the uplink transmission may include a RRC transmission. The RRC transmission may include the first carrier indicator and the second carrier indicator. The RRC transmission may include a ranked list of carrier indicators including the first carrier indicator and the second carrier indicator. In yet another embodiment, the uplink transmission may include a Medium Access Control (MAC) control element (CE), the MAC CE including the first carrier indicator and the second carrier indicator.

In one embodiment. the measuring of the carrier quality may include measuring self-interference within the UE. The self-interference may correspond to interference from uplink carrier transmission by the UE to one or more downlink carriers. The self-interference may correspond to a delta to an SNR caused by the self-interference. Additionally, the first carrier may correspond to an uplink carrier that causes the least amount of measurable self-interference.

In another embodiment, the measuring of the carrier quality may include determining a thermal metric associated with transmission on one or more uplink carriers. The thermal metric may be based a transmit power and/or a thermal measurement associated with transmission on the one or more uplink carriers. The first carrier may correspond to an uplink carrier that is associated with a transmit chain having the lowest thermal metric. The second carrier may correspond to an uplink carrier associated with a transmit chain having the highest thermal metric.

In yet another embodiment, the apparatus may be associated with a RAT, and the carrier quality is based on an interference metric associated non-WWAN communications.

In another aspect of the disclosure, a method, a computer-readable medium, and an apparatus are provided. The apparatus may be a base station. The apparatus may receive an uplink transmission from a user equipment (UE), the uplink transmission may include a first carrier indicator. The first carrier indicator may correspond to a first carrier quality for a first carrier. The apparatus may also schedule uplink transmissions based on the first carrier indicator, and transmit an uplink grant from the base station based on the uplink transmission. The first carrier quality may be a highest carrier quality or a lowest carrier quality. Scheduling uplink transmissions may include adjusting a rate of uplink grants scheduled on the first carrier.

In an embodiment, the uplink transmission may include a second carrier indicator corresponding to a second carrier and a second carrier quality, and the first carrier quality may be a highest carrier quality, and the second carrier quality may be a lowest carrier quality. Additionally, the apparatus may transmit a DTX configuration for at least one of the first carrier and the second carrier based on the first carrier indicator and the second carrier indicator.

In one embodiment, the uplink transmission may be a buffer status report (BSR). The apparatus may transmit an indication of a BSR format, and the BSR format may include a first carrier indicator field and a second carrier indicator field. In another embodiment, the uplink transmission may include an RCC transmission or a Medium Access Control (MAC) control element (CE), The MAC CE may include the first carrier indicator and the second carrier indicator.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network according to some embodiments.

FIG. 2 is a diagram illustrating an example of a base station and user equipment (UE) in an access network according to some embodiments.

FIG. 3 illustrates a table of logical channel ID (LCID) values.

FIG. 4 illustrates a BSR format for communication of carrier IDs.

FIG. 5 is a diagram illustrating a base station in communication with a UE according to some embodiments.

FIG. 6 is a flowchart of a method of wireless communication according to some embodiments.

FIG. 7 is a conceptual data flow diagram illustrating the data flow between different means/components according to some embodiments.

FIG. 8 is a diagram illustrating an example of a hardware implementation for an apparatus employing a processing system according to some embodiments.

FIG. 9 is a flowchart of a method of wireless communication according to some embodiments.

FIG. 10 is a conceptual data flow diagram illustrating the data flow between different means/components according to some embodiments.

FIG. 11 is a diagram illustrating an example of a hardware implementation for an apparatus employing a processing system according to some embodiments.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

In a carrier aggregation or EN-DC scenario, there exist multiple different conditions based on which UE would benefit from a higher or lower grant ratio on a specific carrier as opposed to other carriers. For example, the UE would benefit from indicating a preferred (or non-preferred) carrier to the serving base station. The base station, in turn, could adjust the rate at which uplink grants for the preferred (or non-preferred) carrier is provided to the UE. Furthermore, the preferred (and non-preferred) carrier for a UE may change dynamically based on changing radio conditions.

There are a number of criteria based on which UE may select a preferred carrier for uplink grant reception. Some example criteria explained below include self-jamming conditions, thermal constraints, and inter-RAT interference. These are not the only criteria envisioned as possible bases for identifying preferred carriers, non-preferred carriers, or ranking carriers. Various embodiments described below provide techniques for a UE to indicate preferred and non-preferred carriers to a serving base station. A serving base station, in turn, can make use of the indication to adjust the ratio at which uplink transmissions are scheduled on these carriers.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

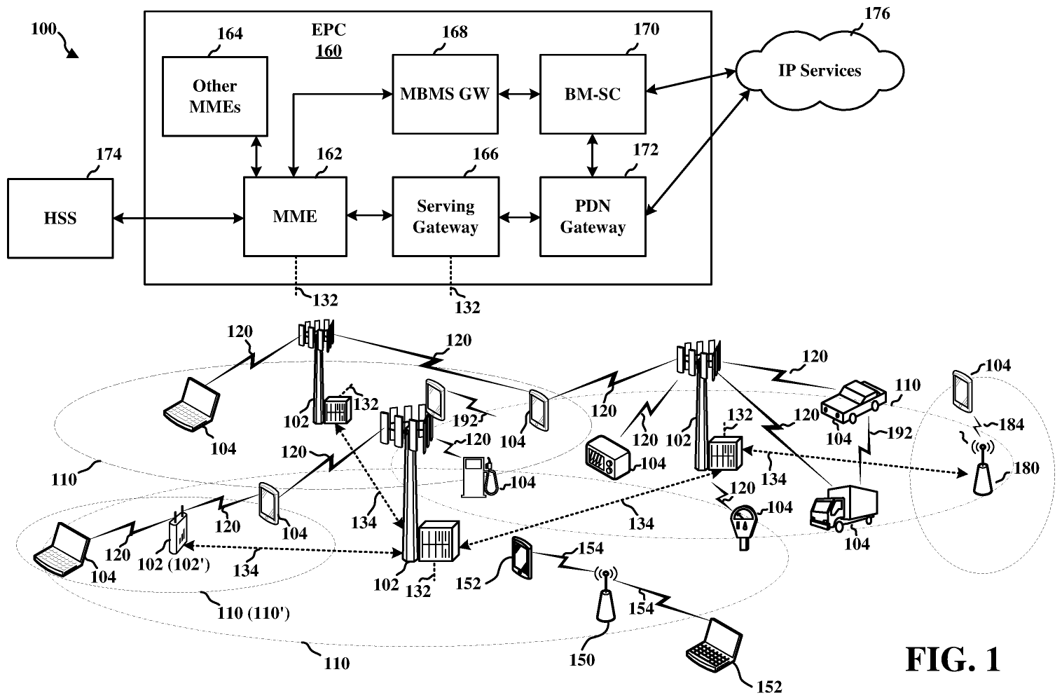

FIG. 1 is a diagram illustrating an example of a wireless communications system and an access network 100. The wireless communications system (also referred to as a wireless wide area network (WWAN)) includes base stations 102, UEs 104, and an Evolved Packet Core (EPC) 160. The base stations 102 may include macro cells (high power cellular base station) and/or small cells (low power cellular base station). The macro cells include base stations. The small cells include femtocells, picocells, and microcells.

The base stations 102 (collectively referred to as Evolved Universal Mobile Telecommunications System (UMTS) Terrestrial Radio Access Network (E-UTRAN)) interface with the EPC 160 through backhaul links 132 (e.g., S1 interface). In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160) with each other over backhaul links 134 (e.g., X2 interface). The backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macro cells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100 MHz) bandwidth per carrier allocated in a carrier aggregation (CA) of up to a total of Yx MHz (x component carriers) used for transmission in each direction. The carriers may or may not be adjacent to each other. Allocation of carriers may be asymmetric with respect to DL and UL (e.g., more or less carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 192. The D2D communication link 192 may use the DL/UL WWAN spectrum. The D2D communication link 192 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, LTE, or NR. The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to and/or increase capacity of the access network.

The gNodeB (gNB) 180 may operate in millimeter wave (mmW) frequencies and/or near mmW frequencies in communication with the UE 104. When the gNB 180 operates in mmW or near mmW frequencies, the gNB 180 may be referred to as an mmW base station. Extremely high frequency (EHF) is part of the RF in the electromagnetic spectrum. EHF has a range of 30 GHz to 300 GHz and a wavelength between 1 millimeter and 10 millimeters. Radio waves in the band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band has extremely high path loss and a short range. The mmW base station 180 may utilize beamforming 184 with the UE 104 to compensate for the extremely high path loss and short range.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The base station may also be referred to as a gNB, Node B, evolved Node B (eNB), an access point, a base transceiver station, a radio base station, a radio transceiver, a transceiver function, a basic service set (BSS), an extended service set (ESS), or some other suitable terminology. The base station 102 provides an access point to the EPC 160 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a prosthetic, medical device, entertainment device, industrial equipment, a vehicle, an electric meter, a gas pump, a large or small kitchen appliance, a healthcare device, an implant, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Referring again to FIG. 1, in certain aspects, the UE 104 may be configured to communicate preferred and non-preferred carriers to base station 102. Base station 102 may be configured to schedule uplink transmissions for UE 104 based on the preferred and non-preferred carriers.

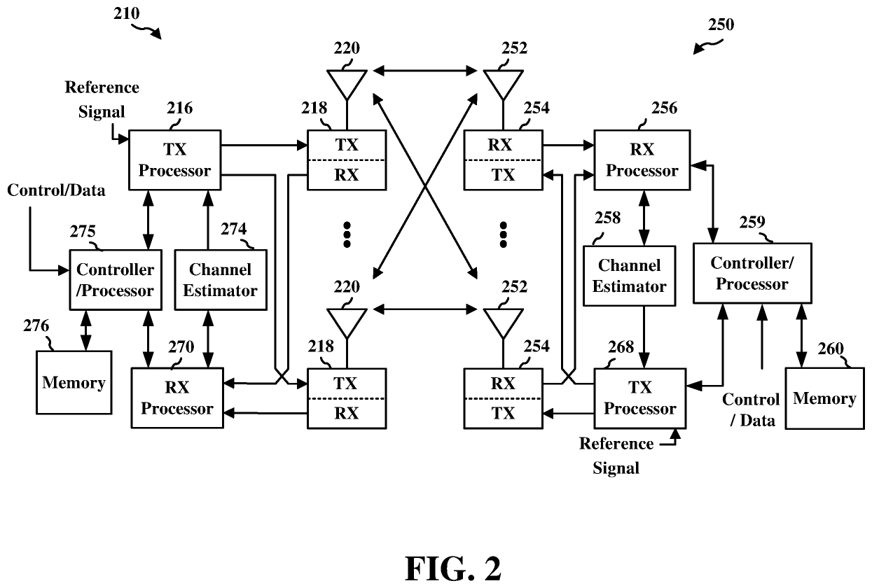

FIG. 2 is a block diagram of a base station 210 in communication with a UE 250 in an access network. In the DL, IP packets from the EPC 160 may be provided to a controller/processor 275. The controller/processor 375 implements layer 3 and layer 2 functionality. Layer 3 includes a radio resource control (RRC) layer, and layer 2 includes a packet data convergence protocol (PDCP) layer, a radio link control (RLC) layer, and a medium access control (MAC) layer. The controller/processor 275 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 216 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 216 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 274 may be used to determine the coding and modulation scheme, as well as for spatial processing. The channel estimate may be derived from a reference signal and/or channel condition feedback transmitted by the UE 250. Each spatial stream may then be provided to a different antenna 220 via a separate transmitter 218TX. Each transmitter 218TX may modulate an RF carrier with a respective spatial stream for transmission.

At the UE 250, each receiver 254RX receives a signal through its respective antenna 252. Each receiver 254RX recovers information modulated onto an RF carrier and provides the information to the receive (RX) processor 256. The TX processor 268 and the RX processor 256 implement layer 1 functionality associated with various signal processing functions. The RX processor 256 may perform spatial processing on the information to recover any spatial streams destined for the UE 250. If multiple spatial streams are destined for the UE 250, they may be combined by the RX processor 256 into a single OFDM symbol stream. The RX processor 256 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 210. These soft decisions may be based on channel estimates computed by the channel estimator 258. The soft decisions are then decoded and deinterleaved to recover the data and control signals that were originally transmitted by the base station 210 on the physical channel. The data and control signals are then provided to the controller/processor 259, which implements layer 2 and layer 2 functionality.

The controller/processor 259 can be associated with a memory 260 that stores program codes and data. The memory 260 may be referred to as a computer-readable medium. In the UL, the controller/processor 259 provides demultiplexing between transport and logical channels, packet reassembly, deciphering, header decompression, and control signal processing to recover IP packets from the EPC 160. The controller/processor 259 is also responsible for error detection using an ACK and/or NACK protocol to support HARQ operations.

Similar to the functionality described in connection with the DL transmission by the base station 210, the controller/processor 259 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 258 from a reference signal or feedback transmitted by the base station 210 may be used by the TX processor 268 to select the appropriate coding and modulation schemes, and to facilitate spatial processing. The spatial streams generated by the TX processor 268 may be provided to different antenna 252 via separate transmitters 254TX. Each transmitter 254TX may modulate an RF carrier with a respective spatial stream for transmission.

The UL transmission is processed at the base station 210 in a manner similar to that described in connection with the receiver function at the UE 250. Each receiver 218RX receives a signal through its respective antenna 220. Each receiver 218RX recovers information modulated onto an RF carrier and provides the information to a RX processor 270.

The controller/processor 275 can be associated with a memory 276 that stores program codes and data. The memory 276 may be referred to as a computer-readable medium. In the UL, the controller/processor 275 provides demultiplexing between transport and logical channels, packet reassembly, deciphering, header decompression, control signal processing to recover IP packets from the UE 250. IP packets from the controller/processor 275 may be provided to the EPC 160. The controller/processor 275 is also responsible for error detection using an ACK and/or NACK protocol to support HARQ operations.

Various wireless communication technologies may have a different frame structure and/or different channels. A frame may be divided into multiple (e.g., 10) equally sized subframes. Each subframe may include multiple consecutive time slots (based on the type of numerology). A resource grid may be used to represent time slots, each time slot may include one or more time concurrent resource blocks (RBs) (also referred to as physical RBs (PRBs)). The resource grid is divided into multiple resource elements (REs). For a normal cyclic prefix, an RB may contain consecutive subcarriers in the frequency domain and consecutive symbols. The number of bits carried by each RE depends on the modulation scheme.

Some of the REs may carry reference (pilot) signals (RS) for downlink channel estimation at the UE. These RS may include cell-specific reference signals (CRS) (also sometimes called common RS), UE-specific reference signals (UE-RS), and channel state information reference signals (CSI-RS).

Various channels may exist within a DL subframe. The PDCCH carries downlink control information (DCI) within one or more control channel elements (CCEs), each CCE including multiple RE groups (REGs), each REG including a number of consecutive REs in an OFDM symbol. A UE may be configured with a UE-specific enhanced PDCCH (ePDCCH) that also carries DCI. The physical hybrid automatic repeat request (ARQ) (HARQ) indicator channel (PHICH) carries the HARQ indicator (HI) that indicates HARQ acknowledgement (ACK)/negative ACK (NACK) feedback based on the success of decoding a physical uplink shared channel (PUSCH). A primary synchronization signal (PSS) may serve to determine subframe/symbol timing and a physical layer identity. A secondary synchronization signal (SSS) that is used by a UE to determine a physical layer cell identity group number and radio frame timing. Based on the physical layer identity and the physical layer cell identity group number, the UE can determine a physical cell identifier (PCI). Based on the PCI, the UE can determine the locations of the downlink RS. A physical broadcast channel (PBCH), carries a master information block (MIB). The PBCH may be logically grouped with the PSS and SSS to form a synchronization signal (SS) block. The MIB provides system configuration information, including a number of RBs in the DL system bandwidth, a PHICH configuration, and a system frame number (SFN). The physical downlink shared channel (PDSCH) carries user data, broadcast system information not transmitted through the PBCH such as system information blocks (SIBs), and paging messages.

Uplink subframes may include REs that carry demodulation reference signals (DM-RS) for channel estimation at the base station. The UE may additionally transmit sounding reference signals (SRS) in the last symbol of a subframe. The SRS may have a comb structure, and a UE may transmit SRS on one of the combs. The SRS may be used by a base station for channel quality estimation to enable frequency-dependent scheduling on the UL.

A physical random access channel (PRACH) may be within one or more subframes within a frame based on the PRACH configuration. The PRACH may include consecutive RB pairs within a subframe. The PRACH allows the UE to perform initial system access and achieve UL synchronization. A physical uplink control channel (PUCCH) may be located on edges of the UL system bandwidth. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data and may additionally be used to carry a buffer status report (BSR), a power headroom report (PHR), and/or UCI.

To obtain an uplink grant from a base station, a UE sends an SR to the base station, e.g., following a random access procedure. In response to the SR, the network may allocate a minimal grant for the UE to send a BSR. The BSR indicates how much buffered data is pending uplink transmission at the UE. The BSR indicates the amount of buffered data using different quantized granularities (e.g., using an index). In response to the BSR, the base station may determine and transmit a suitable grant of uplink resources to the UE.

5G NR supports different types of carrier aggregation. Carrier aggregation is supported within frequency range 1 (FR1) (e.g., sub 6 GHz), within frequency range 2 (FR2) (e.g., mmWave), or as a combination of FR1 and FR2 (e.g., carrier aggregation with Sub 6 Ghz and mmWave carriers). Furthermore, 5G NR also supports EN-DC (EUTRA-NR Dual Connectivity) with at least one carrier on an LTE RAT and at least one carrier on a 5G NR RAT.

With respect to carrier aggregation, the BSR presents a limitation, as buffered data is not indicated per carrier, but as a single value per UE. Accordingly, the UE can indicate the amount of total data pending uplink transmission, but there is no mechanism to identify a preferred carrier from the UE side for the pending data. As such, a UE has no mechanism to specify a carrier on which it would prefer to receive a grant. Instead, the network selects to provide a grant on any of the active carriers.

Most networks employ a combination of CQI reporting from multiple carriers, load balancing, and other scheduling algorithms to determine the carrier on which to provide an uplink grant to the user or the proportions in which grants are distributed across multiple carriers. However, there exist multiple different scenarios and conditions based on which UE would benefit from a higher or lower grant ratio on a specific carrier as opposed to other carriers. In an ideal scenario, the UE could indicate a preferred (or non-preferred) carrier to the serving base station. The base station, in turn, could adjust the rate at which uplink grants for the preferred (or non-preferred) carrier are provided to the UE. Furthermore, the preferred (or non-preferred) carrier for a UE may change dynamically based on radio conditions.

There are a number of criteria based on which UE may prefer a specific carrier for uplink grant reception. Some example criteria explained below include self-jamming conditions, thermal constraints, and inter-RAT interference. These are not the only criteria envisioned as possible bases for identifying preferred carriers, non-preferred carriers, or ranking carriers. The detailed description set forth below in connection with these criteria is not intended to represent the only basis in which the invention may be practiced. The detailed description includes example criteria to provide a thorough understanding of various concepts. However, it will be apparent to those skilled in the art that other criteria may be applied within the scope of the invention.

A first example criterion for identifying preferred carriers, non-preferred carriers, or ranking carriers includes self-jamming and similar interference conditions. In carrier aggregation or EN-DC scenarios, multiple carriers may be actively transmitting or receiving transmission on multiple transceivers. Transmission from one or more uplink carriers could cause self-interference to one of the active downlink carriers. The extent of the self-interference may depend on the in-device isolation between an aggressor transmitter and a victim receiver. The in-device isolation may refer to, for example, the extent to which harmonic or inter-modulation interference from an aggressor transmitter impacts a victim receiver.

In this example, the active uplink carrier causing the least interference to any active receiver would be a preferred carrier and any active uplink carrier which causes the most interference to any active receiver would be the non-preferred carrier. Where there is more than one aggressor transmitter, identifying the preferred (or non-preferred) carrier includes quantifying the interference or self-jamming that is caused to the respective receivers to a metric. This metric may be, for example, SNR-based. A preferred uplink carrier would be the uplink carrier associated with an aggressor transmitter causing the lowest magnitude of self-interference to any victim receiver, subject to a priority metric of the victim. For example, the measurement ranking of the uplink carrier may be based on a magnitude of interference caused to each victim receiver adjusted based on the properties of the receiver. The properties of the receiver may include whether the receiver is operating on a primary carrier or a secondary carrier, whether the victim receiver is idle or associated with a voice session. For example, each victim receiver may be given a priority indicator—a voice receiver has a higher priority than idle receiver for mobile terminated paging, which in turn has a higher priority than data receiver. The magnitude of the interference may be determined, for example, based on a delta between SNR under normal conditions and SNR under self-jamming or interference conditions.

A second example criterion for identifying preferred carriers, non-preferred carrier, or ranking carriers includes thermal constraints. Thermal constraint handling is one of the major concerns in 5G. In a scenario with multiple active uplink carriers, different uplink carriers may be active on different power amplifiers (PA) (for Sub 6 GHz) or different beamers/phasors (for mmW). A thermal (e.g., temperature) metric of each carrier may serve to determine the carrier contributing the most and least to the overall system thermal conditions. The thermal metric may be based on a thermistor reading from different phasors or PAs in a device. For example, a carrier associated with a highest transmit power and thermistor reading may have a greater impact on the overall temperature of the system and would correspond to a non-preferred carrier. Similarly, the carrier with the lowest thermal contribution to the device temperature would be the most preferred carrier. By reducing the ratio of uplink grants on the non-preferred carrier and increasing the ratio of uplink grants on the most preferred carrier, the system could improve the duty cycle of the transmitter components (e.g., PA, phasors, beamers) by allowing them sufficient time to cool down and thereby controlling the temperature of the device.

In an embodiment, the thermal constraints may be determined based on a comparison of active PA thermal readings and average PA thermal readings. For each carrier, the device may track the average transmit power and thermal readings for a last N subframes, and compare a current thermistor reading for active PA/beamer with the average reading. The carrier associated with the PA/phasors with the highest thermistor reading relative to the average reading (beyond a hysteresis) may correspond to a non-preferred carrier (where the hysteresis serves to prevent minor temperature variation from arbitrarily impacting the carrier preference). In response to the preferred carrier indication, the network can respond by providing a thinner grant ratio on the indicated carrier, thereby allowing the PA to go to a lower power mode and cool down.

A third example criterion for identifying preferred carriers, non-preferred carriers, or ranking carriers includes jamming of non-WAN communications (e.g., GNSS). There are scenarios in which the active carrier transmission on 5G NR may jam non-WAN technologies. For example, jamming of GNSS reception is a common scenario.

The present solution for GNSS jamming is to blank GNSS transmissions to the UE when the aggressor is active or perform a power back-off of the aggressor transmission. “Blanking” refers to the practice of modifying the active receiver side such that up to 80% of GNSS subframes are received while there is no active aggressor in the system. However, this extends the sampling period of the GNSS receiver. These solutions suffer from different limitations. For example, with blanking, if an aggressor transmitter is continuously active, excessive blanking may cause GNSS decode failures and poor position fixes. Similarly, power back-off to the aggressor transmit power can cause RLF on cell edge scenarios or power headroom reduction. Both of these limitations can be overcome by indicating a preferred carrier, which is not an aggressor to the active GNSS, and indicating any active aggressor to the GNSS as the non-preferred carrier. Such an approach allocates the thinnest grant ratio to the non-preferred carrier (GNSS aggressor in this example), and thereby allows sufficient non-jamming time to GNSS to perform decodes.

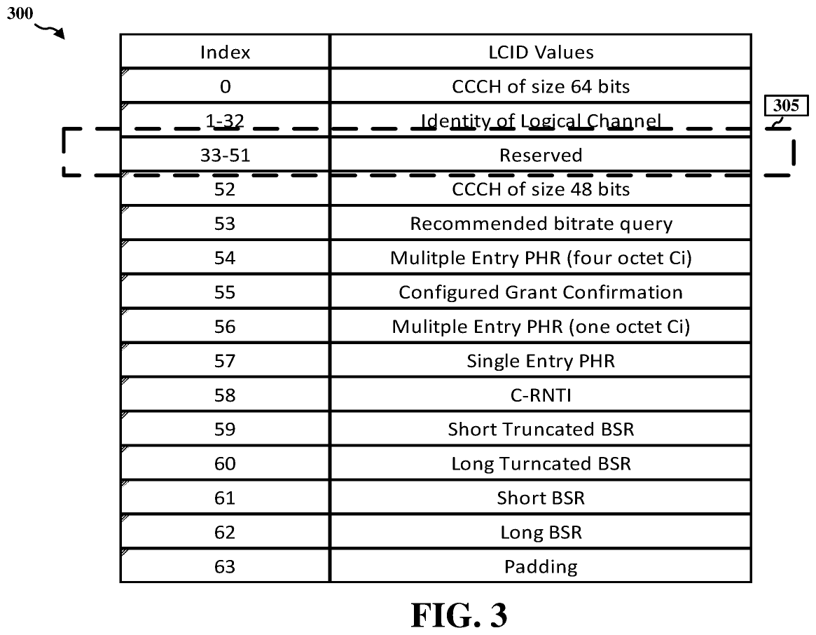

The UE may benefit from a mechanism to indicate a carrier preference to the base station. In one example, an enhanced BSR format may be added that includes fields for signaling one or more carriers to the base station. The base station may indicate to use this enhanced BSR format by providing the UE with a corresponding LCID value. FIG. 3 illustrates a table 300 of LCID values supported by 5G NR. At present, 5G NR supports LCID values for various BSR formats (e.g., short BSR, long BSR, short truncated BSR, long truncated BSR, and padding BSR). The LCID table 300 includes reserved values 305 to support future LCID values. Accordingly, one or more new BSR formats may be associated with a reserved LCID value. For example, a new enhanced BSR associated with LCID value 33 may be added, which includes support for transmission of one or more carrier ID values.

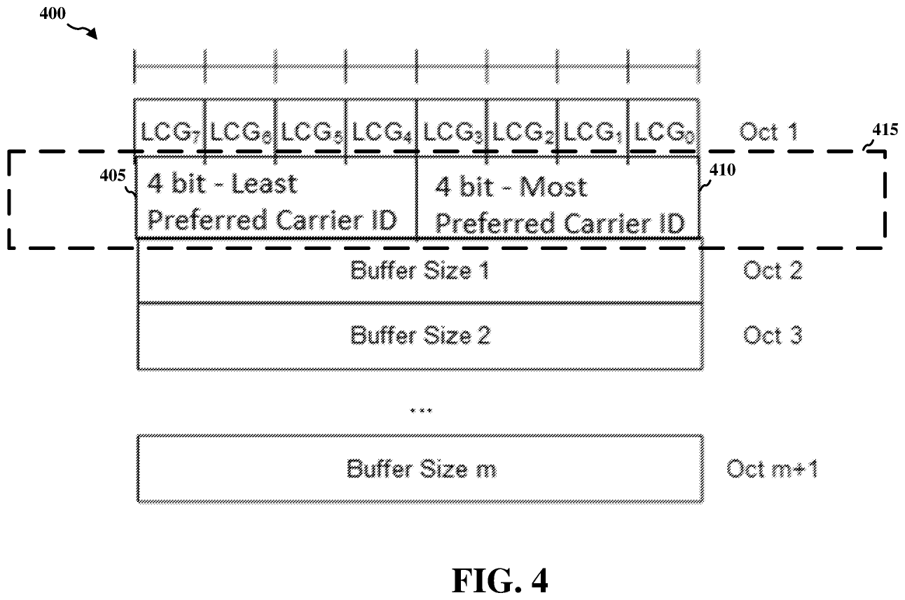

In one example, a new enhanced BSR format may include an additional octet that is defined to include two 4-bit carrier ID values. FIG. 4 illustrates an example BSR format 400 that includes bit indicators for logical channel groups (LCGs) 0-7, an octet 415 for supporting two 4-bit carrier IDs 405, 410, and Octets 2 to m+1 (where m<8) for indicating buffer sizes 1 to m corresponding to the LCG's indicated as present in Octet 1 of the BSR. Buffer sizes 1 to m correspond to index values associated with corresponding buffer sizes of pending uplink data for each of LCG 0-7 indicated as present in Octet 1 of the BSR. The 4 least significant bits 410 may specify a preferred carrier ID, and the 4 most significant bits 405 may specify the non-preferred carrier ID. The 4-bit values allow for 16 possible carrier IDs each. In a variation of the example, to support up to 32 carriers, an entire or portion of a first octet can be reserved to indicate a preferred carrier ID, and an entire or portion of a second octet can be reserved to indicate a non-preferred carrier ID.

In another embodiment, in addition to specifying the preferred carrier and non-preferred carrier, the UE may provide the base station with a ranked list of carriers in order of preference for uplink grants. Given the size of such a communication, this list may be provided via RRC signaling on a periodic basis. This ranking may be regularly updated with BSR transmissions indicating the preferred carriers and/or non-preferred carriers.

In another embodiment, a MAC-CE may be defined to communicate carrier preferences for uplink grants. As the UE radio condition changes, the MAC-CE can be used to update the UE's preference as well. Such a MAC-CE may be configured as part of a periodic transmission in place of, or in addition to, BSR or RRC carrier indications.

The proposed embodiment may further and indirectly provide indications for DTX on a specific carrier. That is, by indicating a non-preferred carrier, the UE may request to initiate DTX on the non-preferred carrier. In another embodiment, an additional UE signaling, or a MAC-CE can be added for a UE to request DTX on a specific carrier for a specific time. Thereby, the UE may provide DTX preferences to the base station based on, for example, thermal, maximum permissible exposure (MPE), interference control, and other UE specific control procedures.

The above embodiment and example provide a UE with additional capability to increase the uplink grant ratio on its preferred active carrier. This may allow the UE to improve performance relative to a device without the ability to adjust carrier ratios under the same network conditions. In this way, various UE specific impairments can be effectively overcome without the need for additional HW, while increasing processing capabilities.

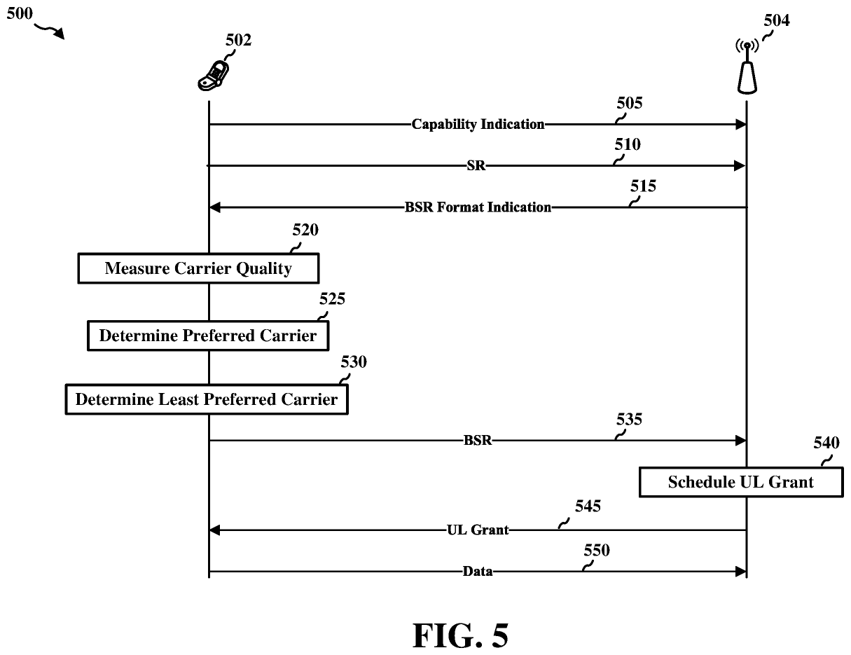

FIG. 5 is a diagram 500 illustrating a base station 504 in communication with a UE 502 according to some embodiments. The diagram 500 illustrates a process by which a UE 502 may identify and communicate a preferred and/or non-preferred uplink carrier to a base station. The UE 502 may be configured to operate using a plurality of carriers. For example, the UE 502 may be configured to use carrier aggregation or EN-DC.

At 505, the UE 502 may provide base station 504 with a capability indication. The capability indication may indicate that the UE 502 supports an ability to identify and transmit an indication of the preferred and/or non-preferred uplink carrier to a base station. This indication may be, for example, an indication of a UE category that supports such measurement and indication. Alternatively, the indication may be indicated via RRC or MAC signaling. Alternatively, the UE may indicate such support during a random-access procedure. Furthermore, the capability may be indicated as part of an SR transmitted to the base station.

At 510, the UE 502 may transmit an SR to base station 504. The SR indicates to base station 504 that UE 502 has buffered data for transmission to the base station 504.

At 515, the base station 504 may transmit a signal to the UE 502 to transmit a BSR. The indication may include a BSR format that the UE 502 should send to the base station. The indicated BSR format may be an enhanced BSR format with fields for indicating a preferred carrier and/or a non-preferred carrier. The carrier indication in the BSR format may include two 4-bit fields for indicating the preferred carrier and non-preferred carrier, or may include one or more 8-bit fields for indicating the preferred and/or non-preferred carrier.

At 520, the UE 502 may measure carrier quality. Step 520 may be performed on a continual basis at the UE, whereby the UE 502 continually monitors carrier quality. Alternatively, the UE 502 may measure carrier quality periodically or in response to certain base station communications, such as receipt of a grant to transmit BSR, or in response to internal conditions (e.g., having buffered data for uplink). Carrier quality may be measured based on one of more UE 502 conditions. As discussed above, these conditions may include, for example, self-jamming between downlink and uplink transmissions, thermal conditions impacting specific carrier and/or transmit chains, and non-WWAN interference. In one embodiment, the UE 502 may rank or prioritize the configured plurality of uplink carriers.

A 525, the UE 502 may determine a preferred carrier from among a plurality of carriers as set forth above.

At 530, the UE 502 may determine a non-preferred carrier from among a plurality of carriers which it is configured to use. Various measurable UE conditions may form the basis for selecting a non-preferred carrier.

Steps 520, 525, and 530 may be performed sequentially or may be performed as a combined step. Accordingly, the UE 502 may rank the carriers and thereby identify the preferred and non-preferred carriers based on the carrier rankings.

At 535, UE 502 may transmit a BSR to the base station 504. The BSR may be an enhanced BSR indicating the preferred carrier and/or the non-preferred carrier. As illustrated in FIG. 4, the carrier indication in the BSR may include two 4-bit fields for indicating the preferred carrier and non-preferred carrier or may include one or more 8-bit fields for indicating the preferred and/or non-preferred carrier.

Alternatively, the UE 502 may indicate the preferred carrier and/or non-preferred carrier via MAC or RRC signaling. The MAC signaling may include transmission of a MAC-CE including fields for the preferred carrier and/or non-preferred carrier, and may be transmitted periodically or aperiodically (e.g., based on a request from the base station). RRC signaling providing carrier preferences may include the preferred carrier and/or non-preferred carrier or may include a ranked list of a plurality of carriers. RRC signaling may also be transmitted periodically or aperiodically.

At 540, the base station 504 may schedule an uplink grant. The uplink grant may be a cross-carrier grant or a self-scheduling grant (depending on the carrier configuration). The base station 540 may schedule the uplink grant for a specific carrier based in-part or in-whole on the preferred carrier and/or non-preferred carrier indication(s) from UE 502. Additionally, the base station may schedule the UE based on measured CQI, network load, QoS requirements, the requirements of other UEs and other network conditions conventionally associated with carrier schedule criteria.

At 545, the base station 504 may transmit an uplink grant to UE 502. The grant may indicate the carrier and resource allocation for transmission of the buffered data. The indicated carrier may correspond to the preferred carrier, or not correspond to the non-preferred carrier.

At 550, the UE 550 may transmit all or a portion of the buffered data to the base station 504 based on the carrier and resource allocation provided in the uplink grant.

Additionally (not shown), the base station 504 may modify the DTX configuration of a UE 502 based on the indication of the non-preferred carrier. For example, the base station 504 may deactivate transmission chains associated with the non-preferred carriers.

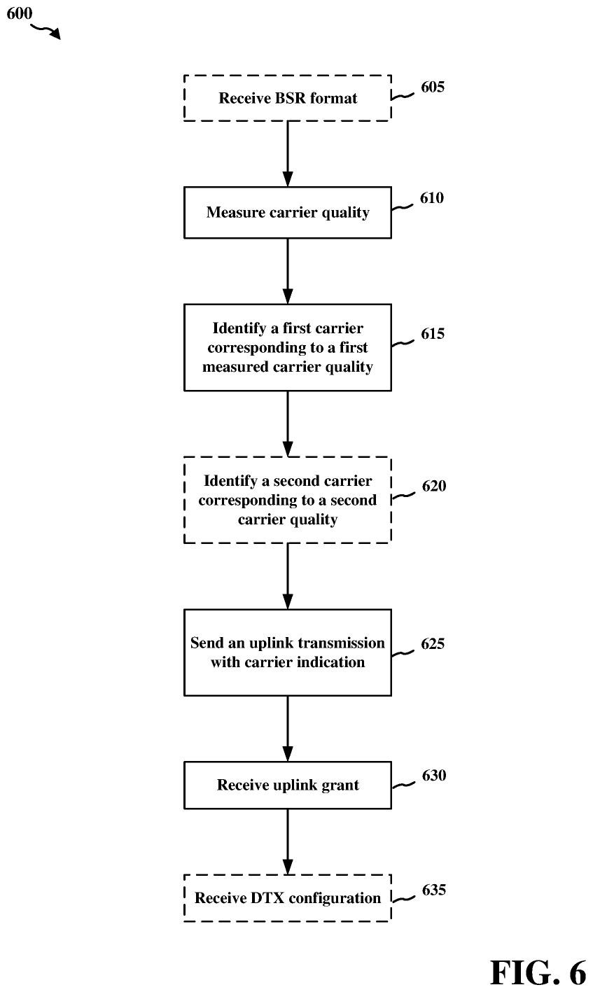

FIG. 6 is a flowchart 900 of a method of wireless communication. The method may be performed by a UE (e.g., the UE 104, 502, the apparatus 802/802′). The method covers a process by which a UE may indicate a preferred carrier for uplink transmission to a base station. The indication may be provided in a BSR, MAC-CE, or RRC communication. In response, the base station may adjust its criteria when selecting a carrier for subsequent uplink transmissions. In flowchart 600, dashed lines represent optional steps.

At 605, the UE may receive a BSR format from the base station. The BSR format may correspond to an enhanced BSR format, with a field to identify one or more carriers to the base station. The base station may indicate for the UE to use this enhanced BSR format by providing the UE with a corresponding LCID value. The new BSR format may include an octet that is defined to include two 4-bit carrier ID values. Alternatively, an entire or a portion of an octet can be reserved to indicate UE's most preferred carrier ID, and an entire or portion of a second octet can be reserved to indicate UE's non-preferred carrier ID.

At 610, the UE may measure carrier quality. A UE configured to employ carrier aggregation or EN-DC may measure carrier quality over a plurality of uplink configured carriers. Carrier quality may be determined based on one of more UE measurable conditions. As discussed above, these conditions may include, for example, self-jamming between downlink and uplink transmissions, thermal conditions impacting specific carrier and/or transmit chains, and non-WWAN interference. In one embodiment, the UE 502 may rank or prioritize the configured uplink carriers.

At 615, the UE may identify a first carrier corresponding to a first measured carrier quality. The first carrier may have a corresponding first measured carrier quality. In one example, the first carrier may be a preferred carrier from among a plurality of carriers. Various measurable UE conditions may form the basis for selecting a preferred carrier. In another example, the carrier may be a non-preferred carrier.

At 620, the UE may identify a second carrier corresponding to a second carrier quality. The second carrier may be one of the plurality of carriers. The second carrier may be selected based on a second measured carrier quality. In one example, the first measured carrier quality may be a highest measured carrier quality associated with the plurality carriers, and the second measured carrier quality may be a lowest measured carrier quality associated with the plurality carriers.

In a first example, the measured carrier quality may correspond to self-interference within the UE. Self-interference may correspond to interference within the UE or to one or more downlink carriers caused by uplink carrier transmissions from the UE. That is, a transmit chain configured to transmit on one carrier may cause interference to a receive chain for another carrier. In this scenario, the measured carrier quality may be based on the magnitude of the self-interference to the downlink carrier that is the victim of the interference. The first carrier corresponds to an uplink carrier that causes the least amount of measurable self-interference.

In a second example, the measured carrier quality may correspond to a thermal metric associated with transmission on one or more uplink carriers. The thermal metric may be based on a transmit power and/or a thermal measurement associated with transmission on the one or more uplink carriers. For example, the thermal measurement may be a thermistor reading of a PA or phaser used for uplink transmission. In this example, the first carrier corresponds to an uplink carrier associated with a transmit chain having the lowest thermal metric. Similarly, the second carrier corresponds to an uplink carrier associated with a transmit chain having the highest thermal metric.

In a third example, the UE employs a non-WWAN network, and the carrier quality is based on interference experienced by a non-WWAN system (e.g., GNSS) due to uplink communications.

At 625, the UE may send an uplink transmission with a carrier indication. The uplink transmission may be a BSR. BSR may have a format including a first carrier indicator field and a second carrier indicator field. Alternatively and as discussed above, the uplink transmission may include a MAC control element (CE) or RRC parameter having the first carrier indicator and the second carrier indicator.

Finally, at 630, the UE may receive an uplink grant. The uplink grant indicates the carrier and resources on which the UE may transmit buffered data.

At 635, the UE may additionally receive a DTX configuration. The DTX configuration may provide indications for DTX on a specific carrier. That is, the base station may indicate to the UE to initiate DTX on the non-preferred carrier. In another embodiment, additional UE signaling (e.g., a MAC-CE) can be introduced for a UE to request DTX on a carrier. Thereby, the UE may use the preferred and non-preferred carrier indication to provide DTX preferences to the base station based on, for example, thermal, MPE, interference control and other UE conditions. As such, the base station may provide a mechanism by which the UE may indicate over-heated transmit chains (e.g., including heavily active mmWave phasers) to the base station, and the base station may use DTX to allow those receive chains to cool down.

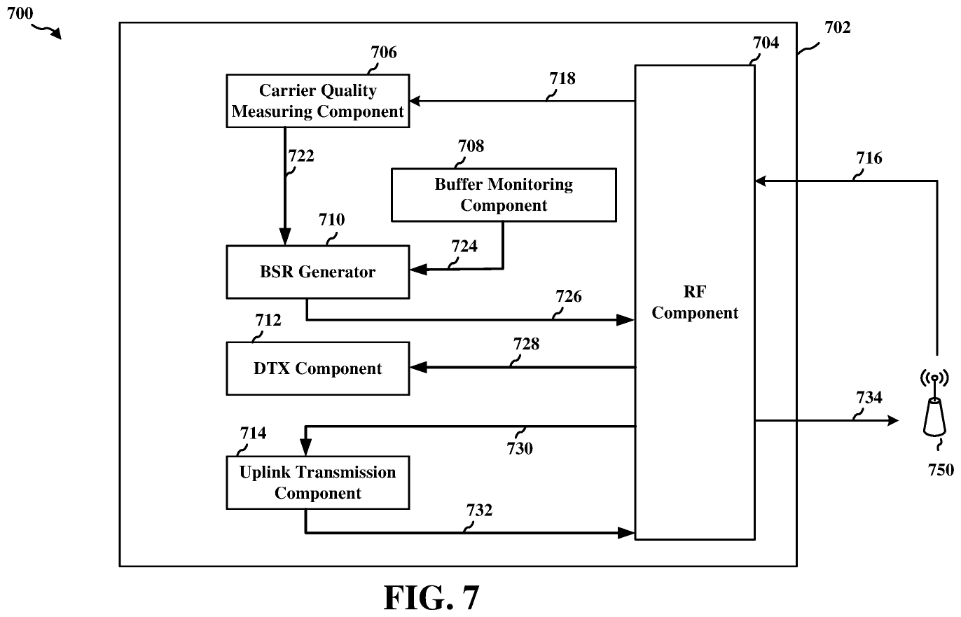

FIG. 7 is a conceptual data flow diagram 700 illustrating the data flow between different means/components in an exemplary apparatus 702. The apparatus may be a UE. The apparatus includes RF component 704, carrier quality measurement component 706, buffer monitoring component 708, BSR generator 710, DTX component 712, and uplink transmission component 714. RF component 704 receives downlink transmission 716 from base station 750 and transmits uplink transmissions 734 to base station 750. Downlink transmissions 716 include various signaling from base station 750, including reference signals, control information (e.g., uplink grants), and data. Uplink transmission 724 may include reference signals, control information (e.g., BSR, MAC-CE), and buffered data. Carrier quality measurement component 706 may receive and measure carrier quality from measurable signals 718 (e.g., reference signals, broadcast signals) received by RF component 704. Buffer monitoring component 708 monitors the quantity of data for uplink transmission at apparatus 702. BSR generator 710 generates a BSR 726 for transmission to base station 750 based on buffer data information 724 and carrier quality preferences/measurements 722. DTX component 712 may receive a DTX configuration 728 from base station 750. Uplink transmission component 714 processes uplink grants 730 from base station 750, and provides uplink data 732 for transmission to base station 750.

The apparatus may include additional components that perform each of the blocks of the algorithm in the aforementioned flowcharts of FIGS. 5 and 6. As such, each block in the aforementioned flowcharts of FIG. 6 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

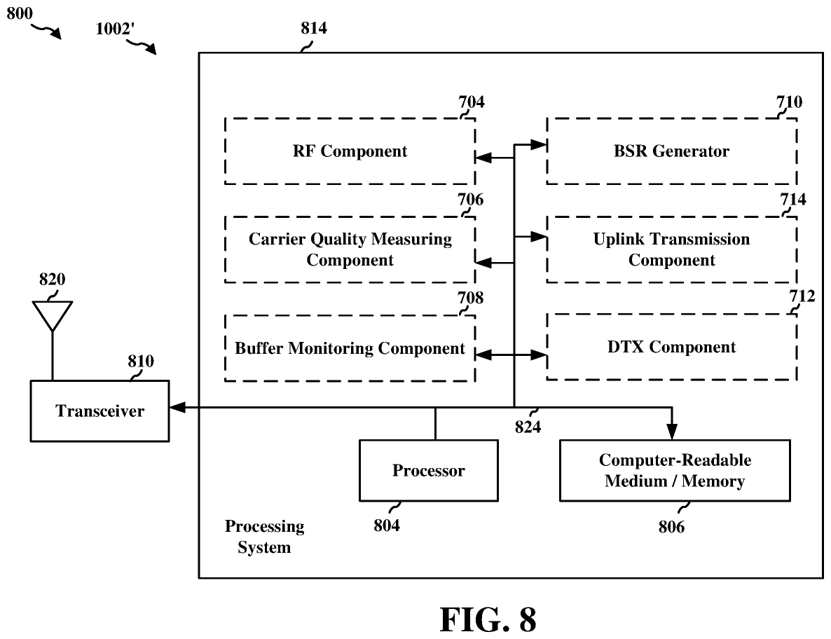

FIG. 8 is a diagram 800 illustrating an example of a hardware implementation for an apparatus 702′ employing a processing system 814. The processing system 814 may be implemented with a bus architecture, represented generally by the bus 824. The bus 824 may include any number of interconnecting buses and bridges depending on the specific application of the processing system 814 and the overall design constraints. The bus 824 links together various circuits including one or more processors and/or hardware components, represented by the processor 804, the components 704, 706, 708, 710, 712, and 74 and the computer-readable medium/memory 806. The bus 824 may also link various other circuits such as timing sources, peripherals, voltage regulators, and power management circuits, which are well known in the art, and therefore, will not be described any further.

The processing system 814 may be coupled to a transceiver 810. The transceiver 810 is coupled to one or more antennas 820. The transceiver 810 provides a means for communicating with various other apparatus over a transmission medium. The transceiver 810 receives a signal from the one or more antennas 820, extracts information from the received signal, and provides the extracted information to the processing system 814, specifically the RF component 704. In addition, the transceiver 810 receives information from the processing system 814, specifically the RF component 704, and based on the received information, generates a signal to be applied to the one or more antennas 820. The processing system 814 includes a processor 804 coupled to a computer-readable medium/memory 806. The processor 804 is responsible for general processing, including the execution of software stored on the computer-readable medium/memory 806. The software, when executed by the processor 804, causes the processing system 814 to perform the various functions described supra for any particular apparatus. The computer-readable medium/memory 806 may also be used for storing data that is manipulated by the processor 804 when executing software. The processing system 814 further includes at least one of the components 704, 706, 708. The components may be software components running in the processor 804, resident/stored in the computer readable medium/memory 806, one or more hardware components coupled to the processor 804, or some combination thereof. The processing system 814 may be a component of the UE 250 and may include the memory 260 and/or at least one of the TX processor 268, the RX processor 256, and the controller/processor 259.

In one configuration, the apparatus 702/702′ for wireless communication includes means for means measuring carrier quality on a plurality of carriers, means for identifying a first carrier from the plurality of carriers, the first carrier corresponding to a first measured carrier quality, means for sending an uplink transmission to a base station, the uplink transmission including an indication of the first carrier, means for receiving an uplink grant from the base station based on the uplink transmission. The aforementioned means may be one or more of the aforementioned components of the apparatus 702 and/or the processing system 814 of the apparatus 702′ configured to perform the functions recited by the aforementioned means. As described supra, the processing system 814 may include the TX Processor 268, the RX Processor 256, and the controller/processor 259. As such, in one configuration, the aforementioned means may be the TX Processor 268, the RX Processor 256, and the controller/processor 259 configured to perform the functions recited by the aforementioned means.

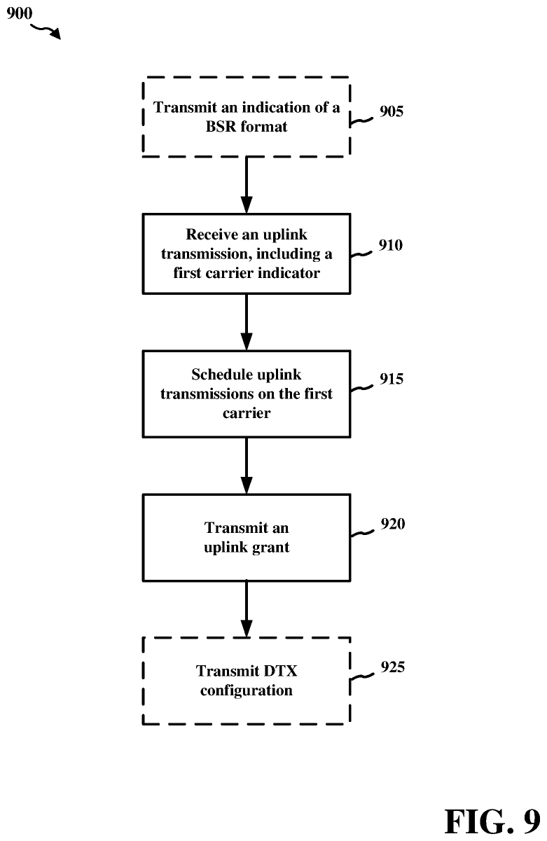

FIG. 9 is a flowchart 900 of a method of wireless communication. The method may be performed by a base station (e.g., the base station 102, 504, or the apparatus 1002/1002′). The method covers a process by which a base station receives a preferred carrier indication from a UE. The indication may be provided via a BSR, MAC-CE, or RRC communication. In response, the base station may adjust its criteria when selecting a carrier for subsequent uplink transmissions. In flowchart 900, dashed lines represent optional steps.

At 902, the base station may transmit an indication of a BSR format. The BSR format may correspond to an enhanced BSR format, with a field to identify one or more carriers to the base station. The base station may indicate for the UE to use this enhanced BSR format by providing the UE with a corresponding LCID value. The BSR format may be provided based on a determined UE capability. For example, the UE may indicate the ability to support the enhanced BSR by indicating a UE category or by providing MAC or RRC communications indicative of supporting an enhanced BSR.

At 904, the base station may receive an uplink transmission, including a first carrier indicator. The first indicator may correspond to a first measured carrier quality. The first measured carrier quality may correspond to a highest measured carrier quality or lowest measured carrier quality. The uplink transmission may also include a second carrier indicator corresponding to a second measured carrier quality, in which case the first measured carrier quality may be a highest measured carrier quality, and the second measured carrier quality may be a lowest measured carrier quality. The uplink transmission may be a BSR (e.g., the enhanced BSR), a MAC control element (CE), or RRC signaling.

At 906, the base station may schedule at least one uplink transmission. Scheduling the uplink transmissions may be based on the first carrier indicator. For example, the base station may adjust a rate of uplink grants scheduled on the first carrier based on the first measured carrier quality. For example, if the first carrier indicator corresponds to a preferred carrier, the base station may increase the ratio of uplink grants on the first carrier. Conversely, if the first carrier indicator corresponds to a non-preferred carrier, the base station may decrease the ratio of uplink grants on the first carrier or not schedule transmissions on the carrier. If the uplink transmission includes both a first carrier indicator associated with a preferred carrier and a second carrier indicator associated with a non-preferred carrier, the base station may increase the grant ratio of uplink grants on the first carrier and decrease the ratio of uplink grants on the second carrier.

Finally, at 908, the base station may transmit an uplink grant to the UE.

At 910, the base station may also transmit a DTX configuration to the UE. The DTX configuration may correspond to the first carrier and second carrier based on the information conveyed by the first carrier indicator and the second carrier indicator. The DTX configuration may provide for DTX on a specific carrier. That is, the base station may indicate to the UE to initiate DTX on the non-preferred carrier. As such, the base station may provide a mechanism by which an over-heated transmit chain (e.g., including active mmWave phasers) may use DTX to cool down.

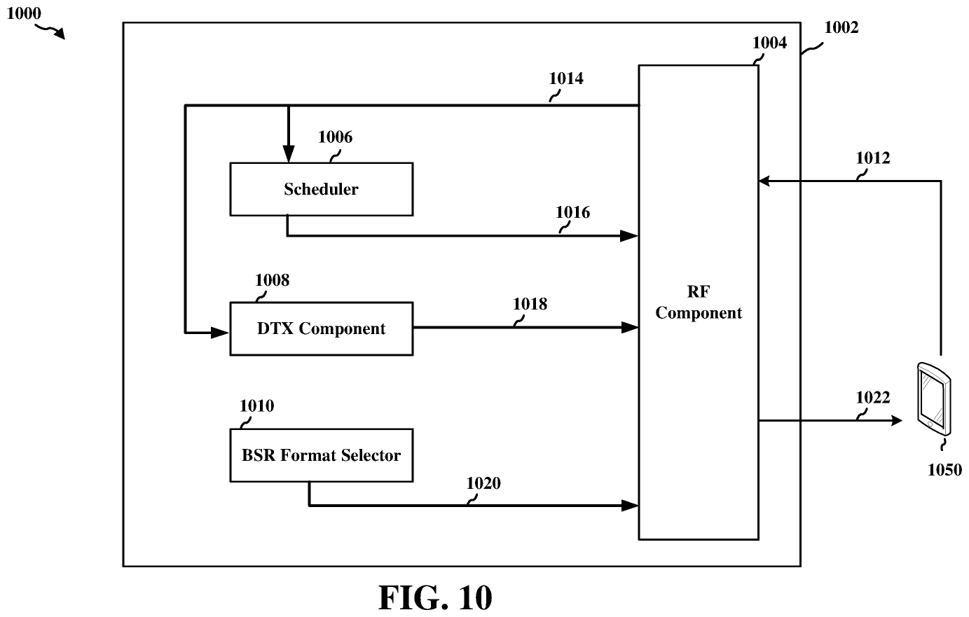

FIG. 10 is a conceptual data flow diagram 1000 illustrating the data flow between different means/components in an exemplary apparatus 1002. The apparatus may be a base station. The apparatus includes RF component 1004, scheduler component 1006, DTX component 1008, and BSR format selector 1010. RF component 1004 transmits downlink transmissions 1022 to UE 1050 and receives uplink transmissions 1012 from UE 1050. Downlink transmissions 1022 include various signaling, including reference signals, control information (e.g., uplink Grants), and data. Uplink transmission 1012 reference signals, control information (e.g., BSR, MAC-CE), and buffered data. Scheduler 1006 receives scheduling control information 1014 (e.g., CQI measurement, BSR) generates downlink assignments and uplink grants 1016 for UE 1050. DTX components generate DTX configurations 1018 for UE 1050 based on UE parameters, including preferred and non-preferred carrier indication information. BSR Format Selector 1010 transmits an indicator 1020 to UE 1050 indicating the type of BSR to transmit to apparatus 1002.

The apparatus may include additional components that perform each of the blocks of the algorithm in the aforementioned flowcharts of FIGS. 5 and 9. As such, each block in the aforementioned flowcharts of FIG. 9 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

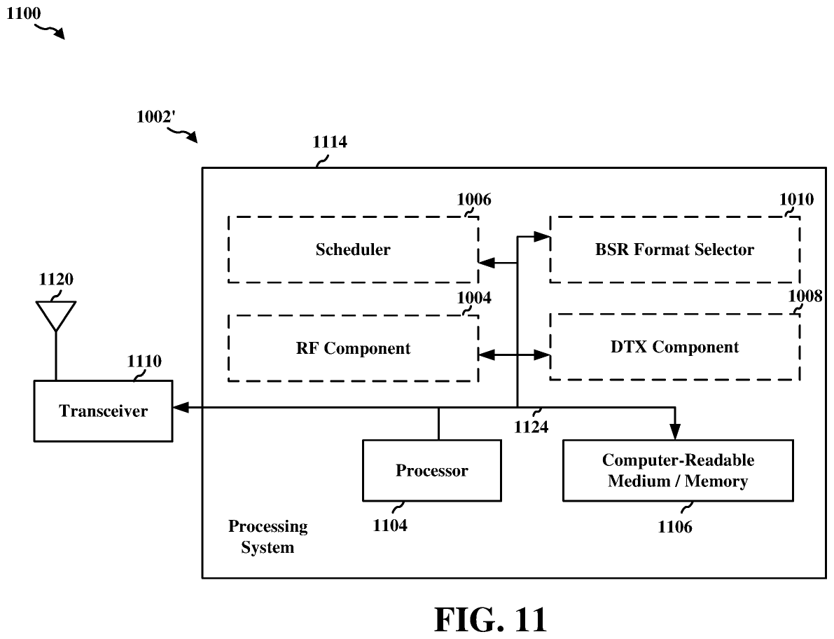

FIG. 11 is a diagram 1100 illustrating an example of a hardware implementation for an apparatus 1002′ employing a processing system 1114. The processing system 1114 may be implemented with a bus architecture, represented generally by the bus 1124. The bus 1124 may include any number of interconnecting buses and bridges depending on the specific application of the processing system 1114 and the overall design constraints. The bus 1124 links together various circuits including one or more processors and/or hardware components, represented by the processor 1104, the components 1004, 1006, 1008, 1010, and the computer-readable medium/memory 1106. The bus 1124 may also link various other circuits such as timing sources, peripherals, voltage regulators, and power management circuits, which are well known in the art, and therefore, will not be described any further.

The processing system 1114 may be coupled to a transceiver 1110. The transceiver 1110 is coupled to one or more antennas 1120. The transceiver 1110 provides a means for communicating with various other apparatus over a transmission medium. The transceiver 1110 receives a signal from the one or more antennas 1120, extracts information from the received signal, and provides the extracted information to the processing system 1114. In addition, the transceiver 1110 receives information from the processing system 1114, and based on the received information, generates a signal to be applied to the one or more antennas 1120. The processing system 1114 includes a processor 1104 coupled to a computer-readable medium/memory 1106. The processor 1104 is responsible for general processing, including the execution of software stored on the computer-readable medium/memory 1106. The software, when executed by the processor 1104, causes the processing system 1114 to perform the various functions described supra for any particular apparatus. The computer-readable medium/memory 1106 may also be used for storing data that is manipulated by the processor 1104 when executing software. The processing system 1114 further includes at least one of the components 1004, 1006, 1008, and 1010. The components may be software components running in the processor 1104, resident/stored in the computer readable medium/memory 1106, one or more hardware components coupled to the processor 1104, or some combination thereof. (The processing system 1114 may be a component of the base station 210 and may include the memory 276 and/or at least one of the TX processor 216, the RX processor 270, and the controller/processor 275

In one configuration, the apparatus_1002/_1002′ for wireless communication includes means for means for receiving an uplink transmission from a, the uplink transmission including a first carrier indicator, the first carrier indicator corresponding to a first measured carrier quality for a first carrier, means for scheduling uplink transmissions based on first carrier indicator, and means for transmitting an uplink grant from the base station based on the uplink transmission. The aforementioned means may be one or more of the aforementioned components of the apparatus_1002 and/or the processing system 1114 of the apparatus_1002′ configured to perform the functions recited by the aforementioned means. As described supra, the processing system 1114 may include the TX Processor 216, the RX Processor 270, and the controller/processor 275. As such, in one configuration, the aforementioned means may be the TX Processor 216, the RX Processor 270, and the controller/processor 275 configured to perform the functions recited by the aforementioned means.

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method for communication by a user equipment (UE), comprising
measuring carrier quality on a plurality of carriers;
identifying a first carrier from the plurality of carriers, the first carrier corresponding to a first measured carrier quality;
sending an uplink transmission to a base station, the uplink transmission including a first carrier indicator corresponding to the first carrier; and
receiving an uplink grant from the base station based on the uplink transmission.

2. The method of claim 1, wherein the first measured carrier quality is one of a highest measured carrier quality or lowest measured carrier quality.

3. The method of claim 1, further comprising identifying a second carrier from the plurality of carriers, the second carrier corresponding to a second measured carrier quality; and wherein the uplink transmission includes a second carrier indicator corresponding to the second carrier, the first measured carrier quality is a highest measured carrier quality, and the second measured carrier quality is a lowest measured carrier quality.

4. The method of claim 3, wherein the uplink transmission includes a buffer status report (BSR).

5. The method of claim 4, further comprising receiving an indication from the base station of a BSR format, wherein the BSR format includes a first carrier indicator field and a second carrier indicator field.

6. The method of claim 1, wherein the measuring of the carrier quality comprises measuring self-interference within the UE, wherein the self-interference corresponds to interference from uplink carrier transmission by the UE to one or more downlink carriers.

7. The method of claim 6, wherein the self-interference corresponds to a delta to an SNR caused by the self-interference.

8. The method of claim 7, wherein the first carrier corresponds to an uplink carrier that causes the least amount of measurable self-interference.

9. The method of claim 3, wherein the measuring of the carrier quality includes determining a thermal metric associated with transmission on one or more uplink carriers.

10. The method of claim 9, wherein the thermal metric is based on one or more of a transmit power and a thermal measurement associated with transmission on the one or more uplink carriers.

11. The method of claim 9, wherein the first carrier corresponds to an uplink carrier that is associated with a transmit chain having the lowest thermal metric.

12. The method of claim 9, wherein the second carrier corresponds to an uplink carrier associated with a transmit chain having the highest thermal metric.

13. The method of claim 3, wherein the uplink transmission includes a RRC transmission, the RRC transmission including the first carrier indicator and the second carrier indicator.

14. The method of claim 3, wherein the uplink transmission includes a RRC transmission, the RRC transmission including a ranked list of carrier indicators that includes the first carrier indicator and the second carrier indicator.

15. The method of claim 3, wherein the uplink transmission includes a Medium Access Control (MAC) control element (CE), the MAC CE including the first carrier indicator and the second carrier indicator.

16. The method of claim 3, further comprising receiving a downlink transmission from the base station including a DTX configuration for at least one of the first carrier and the second carrier in response to the uplink transmission.

17. The method of claim 1, wherein the UE is associated with a RAT, and the carrier quality is based on an interference metric associated non-WWAN communications.

18. A method for communication by base station, comprising
receiving an uplink transmission from a user equipment (UE), the uplink transmission including a first carrier indicator, the first carrier indicator corresponding to a first carrier quality for a first carrier;
scheduling uplink transmissions based on the first carrier indicator; and
transmitting an uplink grant from the base station based on the uplink transmission.

19. The method of claim 18, wherein the first carrier quality is one of a highest carrier quality or a lowest carrier quality.

20. The method of claim 18, wherein scheduling uplink transmissions comprises adjusting a rate of uplink grants scheduled on the first carrier.

21. The method of claim 18, wherein the uplink transmission further includes a second carrier indicator corresponding to a second carrier and a second carrier quality, the first carrier quality is a highest carrier quality, and the second carrier quality is a lowest carrier quality.

22. The method of claim 21, wherein the uplink transmission includes a buffer status report (BSR).

23. The method of claim 22, further comprising transmitting an indication of a BSR format, wherein the BSR format includes a first carrier indicator field and a second carrier indicator field.

24. The method of claim 21, wherein the uplink transmission includes a Medium Access Control (MAC) control element (CE), the MAC CE including the first carrier indicator and the second carrier indicator.

25. The method of claim 21, further comprising transmitting a DTX configuration for at least one of the first carrier and the second carrier based on the first carrier indicator and the second carrier indicator.

26. A user equipment (UE), comprising:
a memory; and
at least one processor coupled to the memory and configured to:
measure carrier quality on a plurality of carriers;
identify a first carrier from the plurality of carriers, the first carrier corresponding to a first measured carrier quality;
send an uplink transmission to a base station, the uplink transmission including an first carrier indicator corresponding to the first carrier; and
receive an uplink grant from the base station based on the uplink transmission.

27. The apparatus of claim 26, wherein the first measured carrier quality is one of a highest measured carrier quality or a lowest measured carrier quality.

28. The apparatus of claim 26, wherein the at least one processor is further configured to identify a second carrier from the plurality of carriers, the second carrier corresponding to a second measured carrier quality; and wherein the uplink transmission includes a second carrier indicator corresponding to the second carrier, the first measured carrier quality is a highest measured carrier quality, and the second measured carrier quality is a lowest measured carrier quality.

29. An apparatus for wireless communication, comprising:
a memory; and
at least one processor coupled to the memory and configured to:
receive an uplink transmission from a user equipment (UE), the uplink transmission including a first carrier indicator, the first carrier indicator corresponding to a first carrier quality for a first carrier;
schedule uplink transmissions based on the first carrier indicator; and
transmit an uplink grant from the base station based on the uplink transmission.

30. The apparatus of claim 29, wherein the first carrier quality is one of a highest carrier quality or a lowest carrier quality.
